(19) United States
(12) Patent Application Publication
(10) Pub. No.: US 2019/0004548 A1
(43) Pub. Date: Jan. 3, 2019

(54) GAS FUEL SUPPLY REGULATOR

(71) Applicant: NIKKI CO., LTD., Kanagawa-ken (JP)

(72) Inventors: Kazuki Kimura, Kanagawa-ken (JP); Yukio Ishida, Kanagawa-ken (JP); Gensaku Konagai, Kanagawa-ken (JP)

(21) Appl. No.: 16/025,795

(22) Filed: Jul. 2, 2018

(30) Foreign Application Priority Data
Jul. 3, 2017 (JP) 2017-130588

(51) Int. Cl. G05D 16/06; F02M 21/02

(52) U.S. Cl. CPC G05D 16/0636; G05D 16/0688; F02M 21/0239

(57) ABSTRACT

In a gas fuel supply regulator, a valve lever a base end of which is firmly fixed to a valve body by a pin arranged on a side of a valve seat of a valve, a rear surface at a leading end of which is supported by a control pressure set spring, and on a surface of which a rod holding recessed part that holds a rod of a diaphragm is formed is slidably arranged, a valve body is opened by fuel of before pressure reduction which fuel is introduced from a fuel inlet to a pressure regulation chamber through the valve, the valve lever is slid, the diaphragm is operated through a coupling mechanism between the rod holding recessed part of the valve lever and the rod of the diaphragm, and pressure of the fuel in the pressure regulation chamber is reduced.

### CROSS-REFERENCE TO RELATED APPLICATION

This application claims priority to Japanese Application JP 2017-130588 filed on Jul. 3, 2017, the contents of which is hereby incorporated by reference in its entirety.

### TECHNICAL FIELD

The present invention relates to a gas fuel supply regulator that is used to transmit a gas fuel such as liquefied petroleum gas (LPG) or compressed natural gas (CNG), which is transmitted from a pressure vessel, to a mixer or an injector while reducing pressure thereof to predetermined pressure.

### BACKGROUND

In a related art, in a case where a gas fuel such as LPG or CNG is supplied to an engine, pressure of a liquid gas fuel with which a pressure vessel is filled is reduced and regulated to low pressure around atmospheric pressure by a regulator, and this is transmitted to a mixer or an injector and supplied from an air inlet pipe line to a gas engine.

The gas fuel supply regulator is disclosed, for example, in Japanese Patent Application Laid-Open No. 2003-232265 and Japanese Patent Application Laid-Open No. 2017-20456. As illustrated in FIG. 6, a valve 5 is provided in a fuel inlet 4 to a pressure regulation chamber 3 comparted by a diaphragm 2 from a side of a back pressure chamber 1 that communicates with an atmosphere side.

Also, the valve 5 includes a valve seat 52 that is provided in an outlet of the fuel inlet 4, that has a tubular shape as a whole, and that includes an opening edge at a top part as a valve contact surface 51, and a valve body 53 having a discoid abutment surface that is closely in contact with the valve contact surface 51. A valve lever 9 a base end of which is firmly fixed to the valve body 53 via a holding member 8 by a pin 7 arranged on a side of the valve seat 52, a rear surface at a leading end of which is supported by a control pressure set spring 6 including a set screw 61 provided according to atmospheric pressure on the side of the back pressure chamber 1, and in a surface of which a rod holding recessed part 91 that holds a rod 21 protruded to a side of the pressure regulation chamber 3 of the diaphragm 2 is formed is slidably arranged. When introduction from the fuel inlet 4 to the pressure regulation chamber 3 through the valve 5 is performed, the valve body 53 is opened, the valve lever 9 is slid, the diaphragm 2 is operated through a coupling mechanism between the rod holding recessed part 91 of the valve lever 9 and the rod 21 of the diaphragm 2, pressure of fuel in the pressure regulation chamber 3 is reduced, and the fuel is discharged from a fuel outlet 10.

Incidentally, as illustrated in FIG. 7, in the gas fuel supply regulator in the related art, with the rod holding recessed part 91 of the valve lever 9 which part is a contact part with the rod 21 of the diaphragm 2 being formed in a spherical surface shape or a round surface shape in order to reduce a positional deviation generated in conversion of a linear motion of the rod 21 of the diaphragm 2 into an arc motion of the valve lever 9 as much as possible, the contact part between the valve lever 9 and the rod 21 of the diaphragm 2 generally has a shape with which it is expected that the rod 21 of the diaphragm 2 slides on the spherical surface part (or round surface part) and goes back to an original position.

Also, as illustrated in FIG. 8B, in an operating state of the diaphragm 2 in the gas fuel supply regulator in the related art, a contact point between the rod 21 and the spherical surface (or round surface) of the rod holding recessed part 91 which point is a contact part between the valve lever 9 and the rod 21 of the diaphragm 2 is deviated compared to an initial state illustrated in each of FIG. 8A and FIG. 8C.

In particular, in a regulator for low pressure control, since a diaphragm 2 of a thin film thickness is used, there is not enough force with which a rod 21 of a diaphragm 2 slides on a spherical surface (or round surface) of a rod holding recessed part 91 of a valve lever 9 and goes back to an original position, and an expected effect is not acquired.

Moreover, as illustrated in FIG. 9, when a contact position c between the rod 21 of the diaphragm 2 and the valve lever 9 varies in a very low flow rate region (state in which valve 5 is not opened much), a lever ratio varies. Thus, a balance is lost and a diaphragm load effort point is placed at d that is varied for a movement amount c with respect to a supplied pressure point a, and a load point b of the control pressure set spring 6, and a difference from an initial set value is generated. There is a problem that controllability/reproducibility of slight pressure is deteriorated. In particular, when a pressure regulating function is deteriorated in a low flow rate region (such as idling region of engine), a rotation trouble of the engine is caused and a serious problem is generated.

### SUMMARY

The present invention is to control a variation in a contact point due to a relative positional deviation generated in a contact part between a valve lever and a rod of a diaphragm, which are included in a gas fuel supply regulator of a related art, during a linear motion of the rod and an arc motion of the valve lever and to improve controllability/reproducibility.

The present invention provided to solve the forgoing is a gas fuel supply regulator in which a valve is provided in a fuel inlet to a pressure regulation chamber comparted by a diaphragm from a side of a back pressure chamber that communicates with an atmosphere side, a valve lever a base end of which is firmly fixed to the valve body by a pin arranged on a side of a valve seat of the valve, and a rear surface at a leading end of which is supported by a control pressure set spring provided according to atmospheric pressure on the side of the back pressure chamber, and on a surface of which a rod holding recessed part that holds a rod protruded to a side of the pressure regulation chamber of the diaphragm is formed is slidably arranged, the valve body is opened by fuel of before pressure reduction which fuel is introduced from the fuel inlet to the pressure regulation chamber through the valve, the valve lever is slid, the diaphragm is operated through a coupling mechanism between the rod holding recessed part of the valve lever and the rod of the diaphragm, and pressure of the fuel in the pressure regulation chamber is reduced, a cross section of the rod holding recessed part of the valve lever being V-shaped.

Also, in the present invention, a tip part of the rod of the diaphragm which part is supported by the rod holding recessed part is formed to have an inclined surface converged toward a center. Thus, a better effect can be acquired.

According to the present invention, since the cross section of the rod holding recessed part of the valve lever which part is in contact with the rod of the diaphragm is V-shaped, a structure in which a contact point is not moved even when the diaphragm is operated (free behavior in rod of diaphragm is controlled) is included. Thus, a variation in a contact point due to a relative positional deviation generated during a linear motion of the rod of the diaphragm and an arc motion of the valve lever can be controlled with respect to a contact part between the valve lever and the rod of the diaphragm of when the valve is opened, and controllability/reproducibility can be improved.

### BRIEF DESCRIPTION OF DRAWINGS

FIG. 1 is a schematic sectional view illustrating a preferred embodiment of the present invention;

FIG. 2 is a view for describing a main part in the embodiment illustrated in FIG. 1;

FIGS. 3A to 3C are views for describing an initial state and an operating state of the embodiment illustrated in FIG. 1;

FIG. 4 is a view for describing a contact part between a rod of a diaphragm and a valve lever in a very low flow rate region (state in which valve is not opened much) in the embodiment illustrated in FIG. 1;

FIG. 5 is a pressure regulation characteristic graph illustrating a relationship between negative pressure and a flow rate in a pressure regulation chamber in the embodiment illustrated in FIG. 1 and that in an example of a related art;

FIG. 6 is a schematic sectional view illustrating an example of a related art;

FIG. 7 is a view for describing a main part in the example of the related art illustrated in FIG. 6;

FIGS. 8A to 8C are views for describing an initial state and an operating state of the example of the related art illustrated in FIG. 6; and

FIG. 9 is a view for describing a contact part between a rod of a diaphragm and a valve lever in a very low flow rate region (state in which valve is not opened much) in the example of the related art illustrated in FIG. 6.

### DETAILED DESCRIPTION

In the following, a preferred embodiment of the present invention will be described in detail with reference to the drawings.

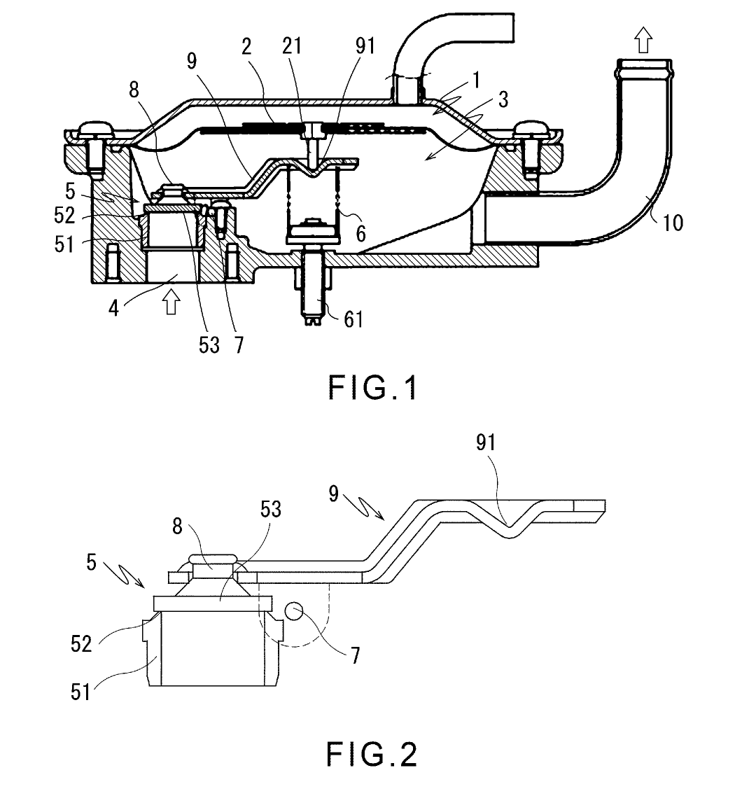

FIG. 1 is a view illustrating a preferred embodiment of the present invention and is basically similar to an example of a related art illustrated in FIG. 6, a detailed description thereof being omitted. In particular, as illustrated in FIG. 2, a point that a cross section of a rod holding recessed part 91 of a valve lever 9 which part supports a rod 21 of a diaphragm 2 is formed in a conical shape a cross section of which is V-shaped is different.

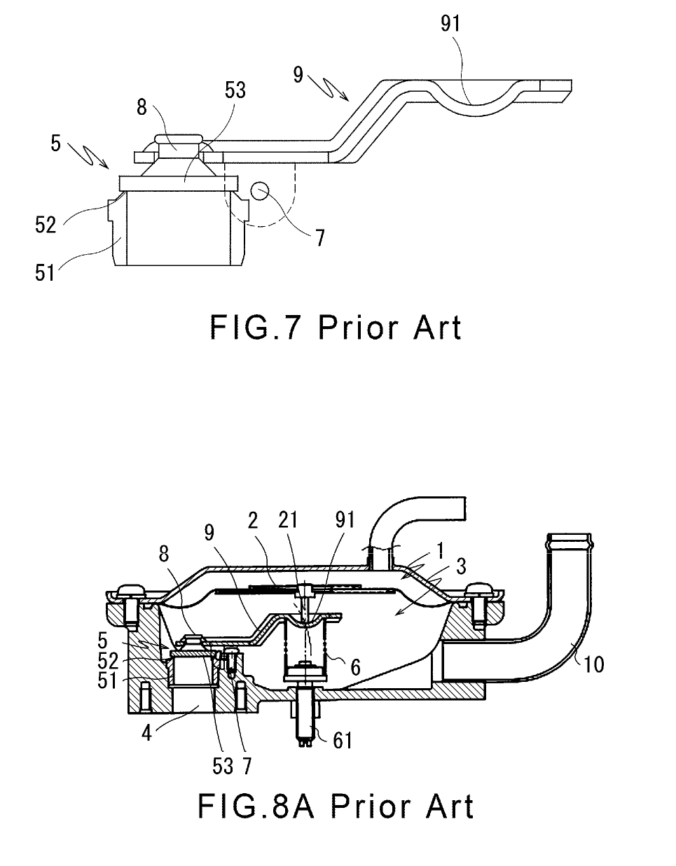

More specifically, as illustrated in FIG. 7, in a gas fuel supply regulator in the related art, with a rod holding recessed part 91 that is a contact part between a valve lever 9 and a rod 21 of a diaphragm 2 being formed in a spherical surface shape or a round surface shape in order to reduce a positional deviation generated in conversion of a linear motion of the rod 21 of the diaphragm 2 into an arc motion of the valve lever 9 as much as possible, the contact part of the valve lever 9 and the rod 21 of the diaphragm 2 has a shape with which it is expected that the rod 21 of the diaphragm 2 slides on a spherical surface part (or round surface part) and goes back to an original position. On the other hand, since a cross section of a rod holding recessed part 91 of a valve lever 9 is formed in a conical shape a cross section of which is V-shaped in the present embodiment, a rod 21 is constantly arranged at a center position of the rod holding recessed part 91 even when an arc motion of the valve lever 9 during pressure regulation is converted into a linear motion of the rod 21 of a diaphragm 2.

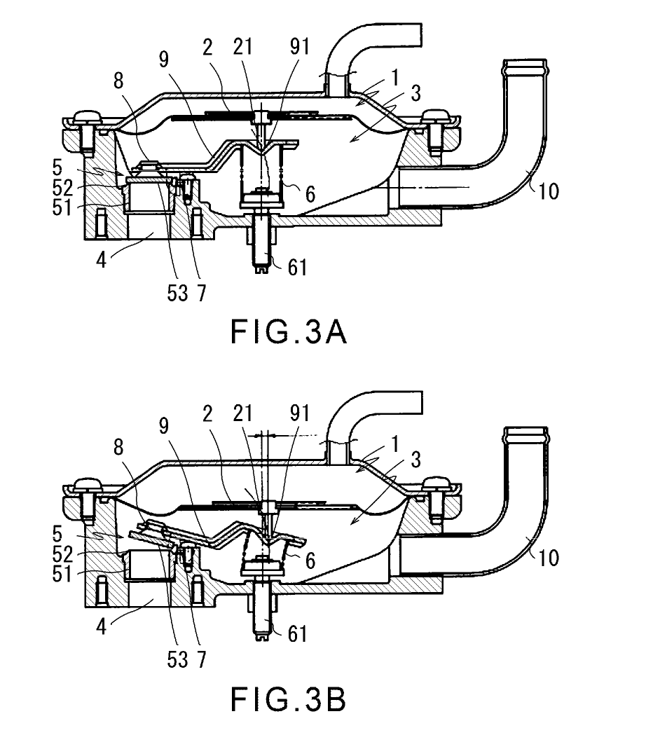

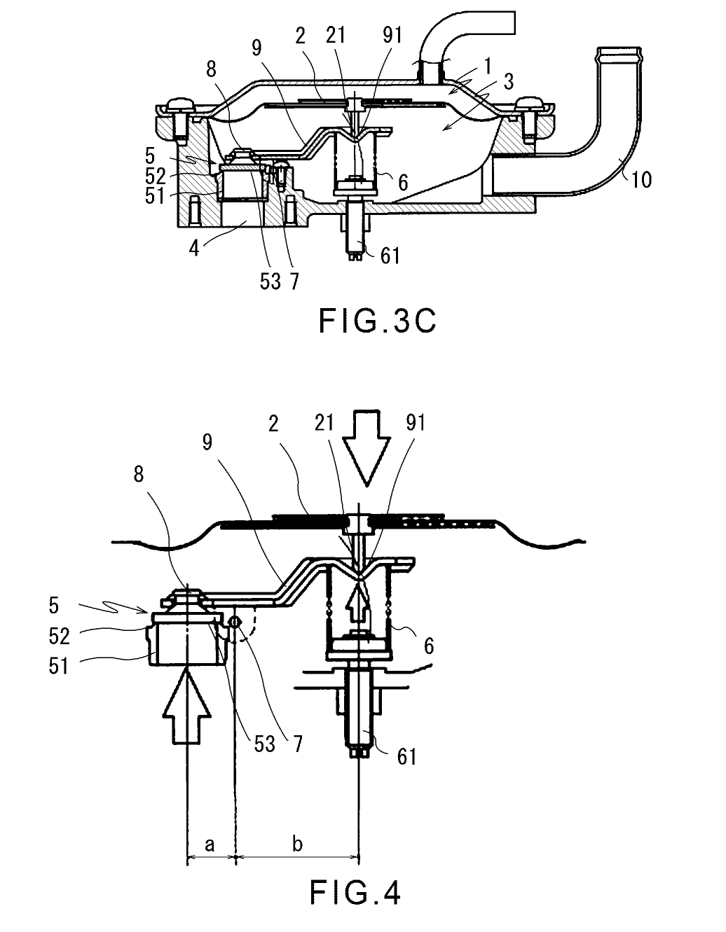

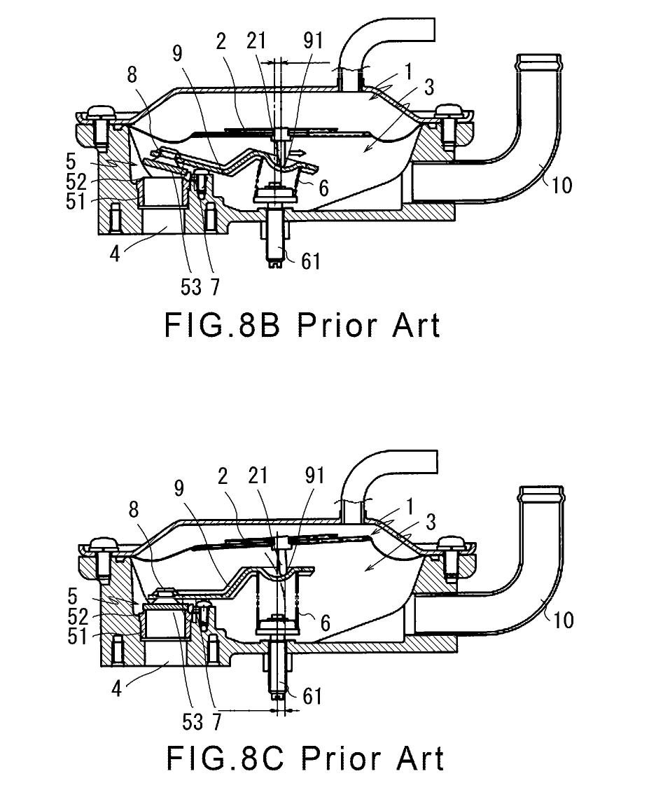

Thus, according to the present embodiment, as illustrated in FIG. 3B, a contact point is not moved from an initial state illustrated in each of FIG. 3A and FIG. 3C (free behavior in rod 21 of diaphragm 2 is controlled) even when the diaphragm 2 is operated, while a contact point with the rod 21 of the diaphragm 2 is deviated in the example of the related art in which the rod holding recessed part 91 with a spherical surface (or round surface) is included and which is illustrated in FIGS. 8A to 8C.

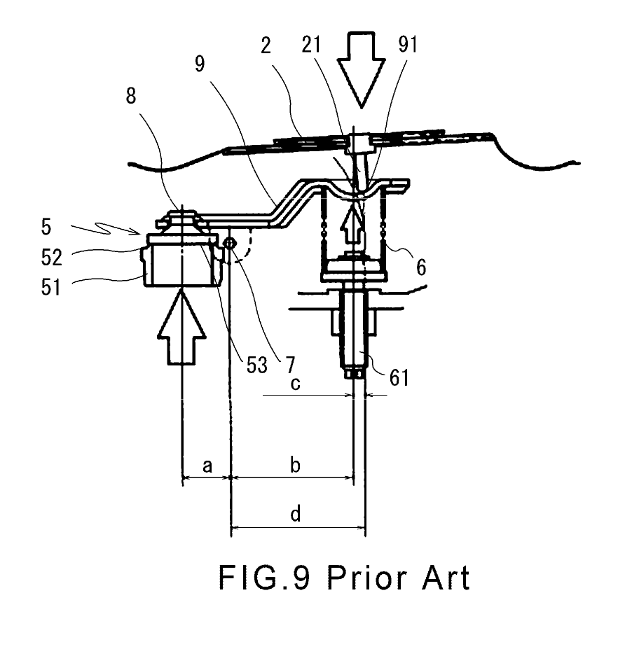

As illustrated in FIG. 4, in a very low flow rate region (state in which valve 5 is not opened much), even when a lever ratio varies, a contact position between the rod 21 of the diaphragm 2 and the valve lever 9 does not vary and a diaphragm load effort point does not vary with respect to a supplied pressure point a, and a load point b of a control pressure set spring 6 unlike the example of the related art illustrated in FIG. 9. Thus, a balance is not lost and a difference from an initial set value is not generated, and there is not a problem of deterioration in controllability/reproducibility of slight pressure.

That is, with respect to a contact part that forms a coupling mechanism between the valve lever 9 and the rod 21 of the diaphragm 2 of when the valve is opened, a variation in a contact point due to a relative positional deviation generated during a linear motion of the rod of the diaphragm and an arc motion of the valve lever can be controlled and controllability/reproducibility can be improved.

In particular, even when a diaphragm 2 of a thin film thickness is used, an expected effect can be acquired since the rod 21 of the diaphragm 2 is arranged at a position of the rod holding recessed part 91 of the valve lever 9.

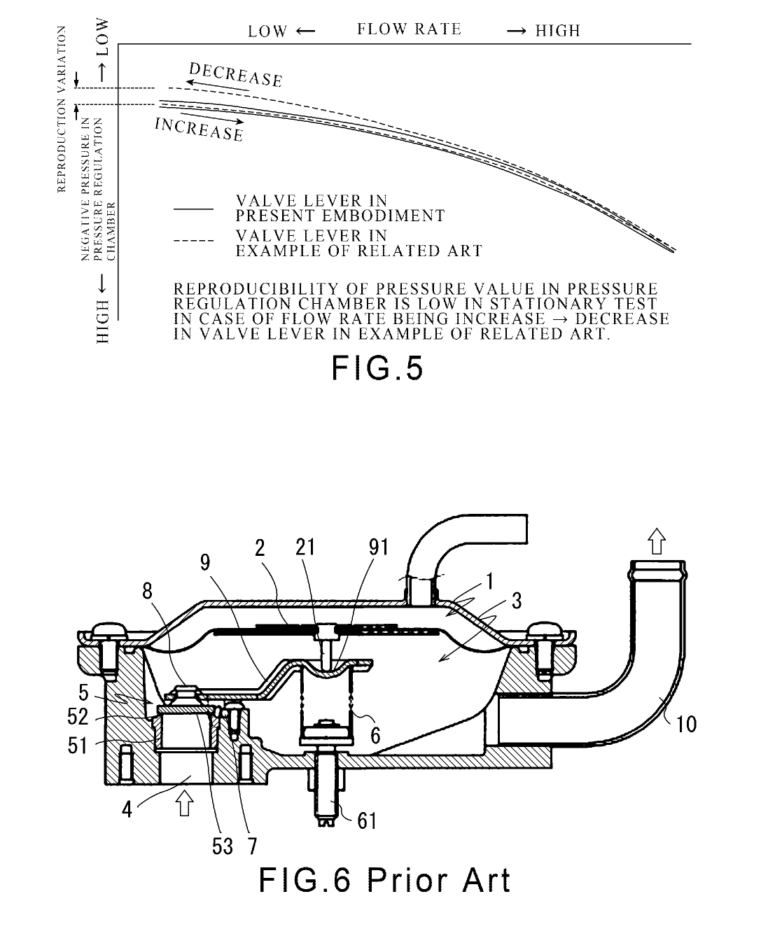

Also, FIG. 5 is a graph illustrating a pressure regulation characteristic relationship indicating a relationship between magnitude of a flow rate and magnitude of negative pressure in a pressure regulation chamber 3 in each of the present embodiment and the example of the related art. It is understood that there is a reproduction variation in negative pressure in the pressure regulation chamber and reproducibility is low in a stationary test when a flow rate varies from an increase to a decrease in the example of the related art in which the valve lever 9 including the rod holding recessed part 91 with a spherical surface or round surface shape is included and which is illustrated in FIG. 6 to FIG. 9 but there is no reproduction variation in the present embodiment.

Also, in the present embodiment, a tip part of the rod 21 in the diaphragm 2 which rod is supported by the rod holding recessed part 91 is formed in a conical shape converging toward a center. Thus, when being supported by the rod holding recessed part 91 formed in a conical shape a cross section of which is V-shaped, a leading end of the rod 21 fits to a center at a bottom part of the rod holding recessed part 91 and is supported in such a manner that central axes of the two are overlapped. For example, the rod 21 is arranged at a position of the rod holding recessed part 91 of the valve lever 9 without being further deviated compared to a case where a rod 21 a leading end of which is columnar is used (not illustrated). Thus, it is possible to more securely acquire a beneficial effect.

1. A gas fuel supply regulator comprising:
a valve being provided in a fuel inlet to a pressure regulation chamber comparted by a diaphragm from a side of a back pressure chamber that communicates with an atmosphere side; and
a valve lever including a base end that is firmly fixed to a valve body by a pin arranged on a side of a valve seat of the valve, a rear surface at a leading end of which is supported by a control pressure set spring provided according to atmospheric pressure on the side of the back pressure chamber, and a surface having a rod holding recessed part slidably arranged thereon and that holds a rod protruded to a side of the pressure regulation chamber of the diaphragm,
wherein the valve body is opened by fuel of before pressure reduction which fuel is introduced from the fuel inlet to the pressure regulation chamber through the valve, the valve lever is slid, the diaphragm is operated through a coupling mechanism between the rod holding recessed part of the valve lever and the rod of the diaphragm, and pressure of the fuel in the pressure regulation chamber is reduced, and
wherein a cross section of the rod holding recessed part of the valve lever is V-shaped.

2. The gas fuel supply regulator according to claim 1, wherein a tip part of the rod of the diaphragm, which rod is supported by the rod holding recessed part, is formed to have an inclined surface converging toward a center.
